(19) United States
(12) Patent Application Publication
(10) Pub. No.: US 2025/0245511 A1
(43) Pub. Date: Jul. 31, 2025

(54) COMPUTING SYSTEMS AND METHODS FOR DATA PROCESSING USING A GENERIC LARGE LANGUAGE MODEL AND A SECONDARY LARGE LANGUAGE MODEL CONFIGURED FOR STRUCTURED DATA

(71) Applicant: The Toronto-Dominion Bank, Toronto (CA)

(72) Inventors: Dino Paul D'Agostino, Richmond Hill (CA); Victor Mao, Markham (CA); Waqas Nawaz, Waterdown (CA); Lamar Kyle Pinto, Mississauga (CA); Jason Kim Kang Trang, Toronto (CA); Scott Bradley Atkins, Toronto (CA); Russell Spinks, Toronto (CA); Anzhela Naherniuk, Toronto (CA)

(21) Appl. No.: 18/424,132

(22) Filed: Jan. 26, 2024

(51) Int. Cl. G06N 3/0895

(52) U.S. Cl. CPC G06N 3/0895

(57) ABSTRACT

Systems and methods for processing input data using a generic large language model (LLM) and a secondary LLM, whereby the secondary LLM is configured to process structured data. An application is provided, including a semantic kernel, a manager module, and a plurality of workers. An input is received via the semantic kernel. The manager module invokes the plurality of workers comprising a first worker and a second worker. The first worker invokes the generic LLM and the second worker invokes the secondary LLM.

### TECHNICAL FIELD

The disclosed exemplary embodiments relate to computer-implemented systems and methods for data processing using a generic large language model (LLM) and a secondary LLM configured for structured data.

### BACKGROUND

Many documents revised or filled by end users or entities may be examined using predetermined metrics to validate that information provided in certain structured fields is in a desired format. However, it may be more difficult to formulate and apply predetermined metrics to determine when certain unstructured data is incomplete or contains inaccurate information.

Software programs can be used to filter, augment or even prepare the documents, or other types of data records. It is recognized, however, that unstructured data (e.g., natural language text) can be difficult to automatically analyze and prepare. The difficulty also increases when data includes a combination of unstructured data and structured data.

### SUMMARY

The following summary is intended to introduce the reader to various aspects of the detailed description, but not to define or delimit any invention.

In at least one broad aspect, there is provided a system for processing input data, the system comprising: a memory, a communication interface, and a processor operatively coupled to the memory and the communication interface; an application stored in the memory and executable by the processor, and the application comprising a semantic kernel, a manager module, and a plurality of workers. The processor is configured to: receive an input via the semantic kernel; invoke, using the manager module, the plurality of workers comprising a first worker and a second worker; invoke, using the first worker, a generic large language model; and invoke, using the second worker, a secondary large language model, wherein the secondary large language model is configured to process structured data.

In some cases, the secondary large language model is trained using specific domain knowledge.

In some cases, the secondary language model is private to an organization, and the specific domain knowledge comprises training data labeled as private to the organization; wherein the generic language model is public; and wherein the input comprises structured input data labeled as private to the organization and unstructured natural language.

In some cases, the manager module invokes the plurality of workers in a stepwise sequence, including invoking the first worker first, and after determining the first worker has completed a first process, the manager module invokes the second worker.

In some cases, the input comprises unstructured input data and structured input data, and the first worker invokes the generic large language module by at least generating a first prompt based on the unstructured data input and sending the first prompt to the generic large language model.

In some cases, the second worker invokes the secondary large language module by at least generating a second prompt based on the structured input data and sending the second prompt to the secondary large language model.

In some cases, the application further comprises a plurality of connectors that are in data communication with the semantic kernel, the plurality of connectors comprising a first connector configured to communicate with the generic large language model and a second connector configured to communicate with the secondary large language model. In some cases, the first worker generates a first prompt that is transmitted via the semantic kernel and the first connector to the generic large language model. In some cases, the second worker generates a second prompt that is transmitted via the semantic kernel and the second connector to the secondary large language model.

In some cases, the processor is further configured to: determine, using the manager module, a goal derived from the input; determine, using the manager module, that the plurality of workers is associated with the goal; and determine, using the plurality of workers, a plurality of prompts organized in a hierarchy to send to generic large language model and to the secondary large language model.

In some cases, the plurality of workers further comprises a third worker, and the processor is further configured to: invoke, using the third worker, the generic large language model and the secondary large language model.

In some cases, the processor is further configured to: receive, via the manager module, a first intermediate result from the first worker and a second intermediate result from the second worker; transmit the first intermediate result and the second intermediate result from the manager module to the semantic kernel; merge, using the semantic kernel, the first intermediate result and the second intermediate result to generate a reply, wherein the reply comprises unstructured output data; and output the reply using the semantic kernel.

In at least another broad aspect, a method for processing input data is provided. The method is executed in a computing environment comprising one or more processors and memory, wherein the memory stores at least an application, the application comprising a semantic kernel, a manager module, and a plurality of workers. The method comprising: receiving an input via the semantic kernel; invoking, using the manager module, the plurality of workers comprising a first worker and a second worker; invoking, using the first worker, a generic large language model; and invoking, using the second worker, a secondary large language model, wherein the secondary large language model is configured to process structured data.

In some cases, the secondary large language model is trained using specific domain knowledge.

In some cases, the secondary language model is private to an organization, and the specific domain knowledge comprises training data labeled as private to the organization; wherein the generic language model is public; and wherein the input comprises structured input data labeled as private to the organization and unstructured natural language.

In some cases, the method further comprising: the manager module invoking the plurality of workers in a stepwise sequence, including invoking the first worker first, and after determining the first worker has completed a first process, the manager module invoking the second worker.

In some cases, the input comprises unstructured input data and structured input data, and wherein the first worker invokes the generic large language module by at least generating a first prompt based on the unstructured data input and sending the first prompt to the generic large language model.

In some cases, the second worker invokes the secondary large language module by at least generating a second prompt based on the structured input data and sending the second prompt to the secondary large language model.

In some cases, the application further comprises a plurality of connectors that are in data communication with the semantic kernel, the plurality of connectors comprising a first connector configured to communicate with the generic large language model and a second connector configured to communicate with the secondary large language model; and wherein the method further comprising: the first worker generating a first prompt that is transmitted via the semantic kernel and the first connector to the generic large language model; and the second worker generates a second prompt that is transmitted via the semantic kernel and the second connector to the secondary large language model.

In some cases, the method further comprising: determining, using the manager module, a goal derived from the input; determining, using the manager module, that plurality of workers are associated with the goal; and determining, using the plurality of workers, a plurality of prompts organized in a hierarchy to send to generic large language model and to the secondary large language model.

In some cases, the plurality of workers further comprises a third worker, and the method further comprising: invoking, using the third worker, the generic large language model and the secondary large language model.

In some cases, the method further comprising: receiving, via the manager module, a first intermediate result from the first worker and a second intermediate result from the second worker; transmitting the first intermediate result and the second intermediate result from the manager module to the semantic kernel; merging, using the semantic kernel, the first intermediate result and the second intermediate result to generate a reply, wherein the reply comprises unstructured output data; and outputting the reply using the semantic kernel.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing documents in accordance with at least some embodiments;

FIG. 1B is a schematic block diagram of a cloud-based computing cluster of FIG. 1A, including an application configured to process input data using a generic LLM and a secondary LLM, the secondary LLM configured for structured data, in accordance with at least some embodiments;

FIG. 2 is a block diagram of a computer in accordance with at least some embodiments;

FIG. 3 is a schematic block diagram of a manager module and its data components in accordance with at least some embodiments;

FIG. 4 is a schematic block diagram of the manager module shown in FIG. 3, with an alternative embodiment of an example stepwise process, in accordance with at least some embodiments;

FIG. 5 is a schematic block diagram of the manager module shown in FIG. 3, with another alternative embodiment of an example stepwise process, in accordance with at least some embodiments;

FIG. 6 is a flowchart diagram of an example method of processing input data using a generic LLM and a secondary LLM, the secondary LLM configured for structured data, in accordance with at least some embodiments;

FIG. 7 is a flowchart diagram of another example method of processing input data using a generic LLM and a secondary LLM, the secondary LLM configured for structured data, in accordance with at least some embodiments; and

FIG. 8 is a graphical user interface of an application UI providing controls for receiving user inputs for different topics of a document, and processing the user inputs for each topic to provide feedback, rationale and recommended replacement description, in accordance with at least some embodiments.

### DETAILED DESCRIPTION

In some cases, software programs can be used to prepare documents, such a requests to obtain a permission, requests to acquire an asset, requests to obtain credit, or other types of documents. In some cases, software programs are used to prepare other types of data records. It is recognized, however, documents that include a combination of unstructured data (e.g., natural language) and structured data are difficult to automatically analyze and prepare feedback. Furthermore, in the case when using large language models (LLMs) in a software program, the operations of training the LLMs and sending data to the LLMs may create data security risks. In particular, many LLMs are provided by third parties and are considered public LLMs.

In some cases, a system is herein provided for processing data, including a computing environment that stores and runs an application. The application includes a semantic kernel, a manager module, and a plurality of workers. The application is in data communication with a generic LLM and a secondary LLM. The application is configured to: receive an input via the semantic kernel; invoke, using the manager module, the plurality of workers comprising a first worker and a second worker; invoke, using the first worker, the generic large language model; and, invoke, using the second worker, a secondary large language model, wherein the secondary large language model is configured to process structured data.

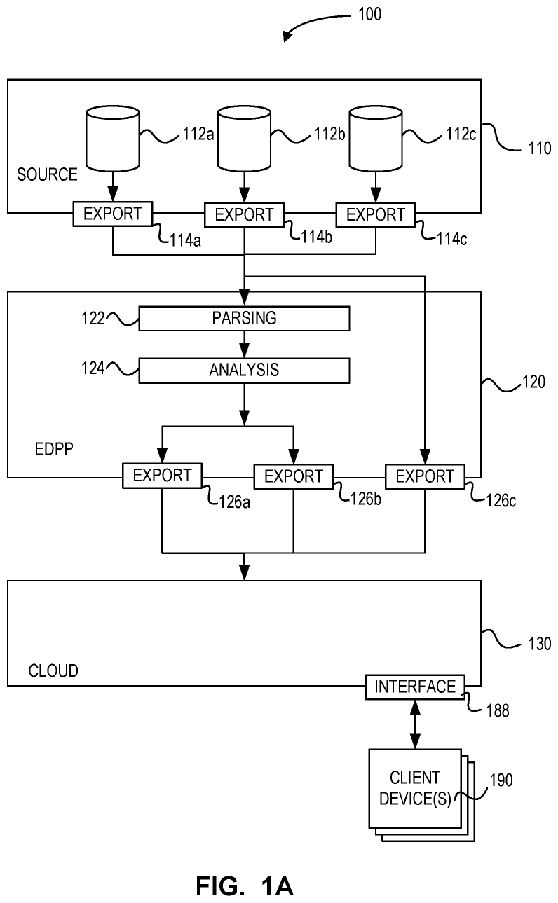

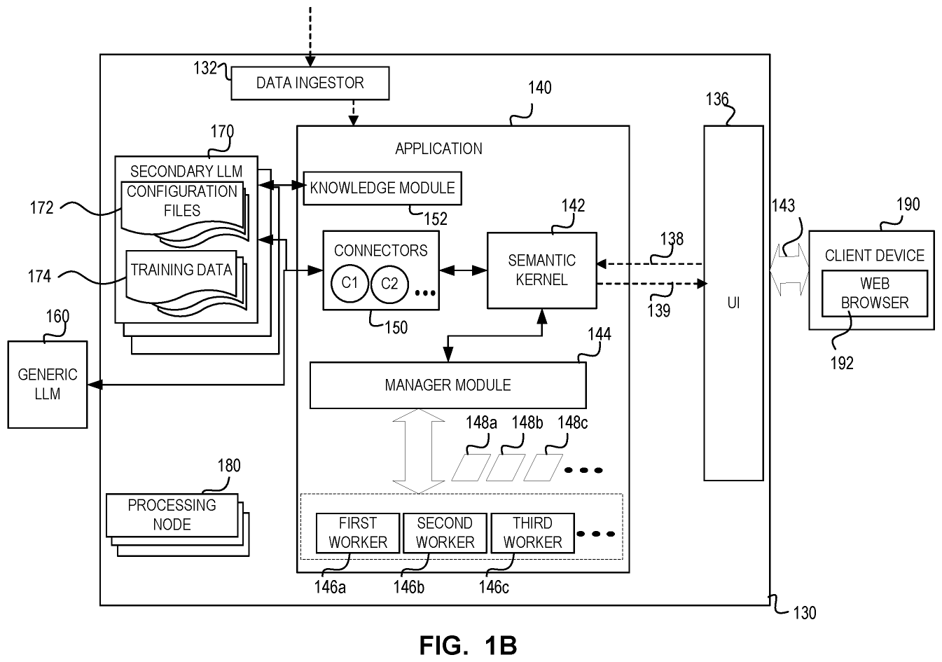

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including computing a time series of predicted characteristics of assets identified within the large data sets.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis. In some cases, the export data may be exported in the form of comma separated value (CSV) data, however other formats may also be used.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a data ingestor 132, an application 140, a user interface (UI) 136 for the application 140, a generic LLM 160, and a secondary LLM 170 are implemented as one or more processing nodes 180 in the cloud-based computing cluster. In some cases, these components are implemented as virtual machines within the cloud-based computing cluster.

In some cases, there are multiple secondary LLMs 170 and each secondary LLM is trained on different configuration files 172 or different training data 174, or both. In some cases, a first instance of a secondary LLM is trained to process a first set of structured data, and a second instance of a secondary LLM is trained to process a second set of structured data.

In some cases, data from the data ingestor 132 is transmitted to the knowledge module 152 in the application 140, and the knowledge module 152 uses the ingested data to update one or more configuration files 172, or one or more training data sets 174, or both. In other words, the knowledge module 152 in some cases is used to modify or update one or more instances of the secondary LLM 170.

In some cases, the described system processes input data using both a generic LLM and a secondary LLM, whereby the secondary LLM is customized. The generic LLM 160 is, for example, ChatGPT available by OpenAl. Other types of generic LLMs suitable for processing natural language can be used. In some cases, the generic LLM is trained for processing unstructured natural language. In some cases, the one or more secondary LLMs 170 are trained using structured data and are each private. For example, the one or more secondary LLMs 170 are private to an organization and trained using the organization's private data. In some cases, the secondary LLM 170 is trained using specific domain knowledge, which can include data that is private to the organization.

In some cases, the unstructured natural language is text provided by the user. In some cases, the structured data includes extensible markup language (XML) data or JavaScript Object Notation (JSON) data, or both. In some cases, the generic LLM 160 cannot process (or cannot accurately process) the structured data, including the XML data or the JSON data, or both. However, the secondary LLM is configured to and trained to process the structured data, including the XML data or the JSON data or both. In some cases, the XML data or the JSON data, or both, are automatically added to the input by a process of the semantic kernel 142, or by a process of the UI 136, or by a process of the knowledge module 152, or another process, or by a combination of one or more of these processes.

In some cases, the one or more secondary LLMs reside and operate in the organization's computing environment. For example, the secondary LLM resides in a private cloud-based computer cluster. In another example, the secondary LLM resides on-premise on the organization's computing environment. The generic LLM 160 resides and operates in a public computing environment.

The application 140 includes a semantic kernel 142, a manager module 144, and a plurality of workers 146. A plurality of workers includes a first worker 146a, a second worker 146b and a third worker 146c. The manager also includes one or more connectors 150 including the connector C1 for connecting to the generic LM160 and the connector C2 for connecting to the secondary LLM 170.

The semantic kernel 142 receives an input 138 from the UI 136, whereby the input 138 may be obtained from a user interaction on a client device 190. In some cases, the client device 190 includes a web browser 192 which displays the UI 136, and user interactions and data transfer between the client device 190 and the UI136 occur through communication 143. For example, the UI 136 is the interface 188, or forms part of the interface 188.

In some cases, the input data 138 includes both structured data and unstructured data, which may form a document (e.g., a request for permission, a request to obtain an asset, a request to obtain credit, etc.) by a user or an entity. In some cases, the structured data and the unstructured data are private and are used to train the secondary LLM. In some cases, the structured data from past similar types of documents are used to train the secondary LLM.

The input data 138 is sent to the application 140 that is configured to provide a reply 139, which can include unstructured natural language. The reply, in some cases, also includes structured data. In some cases, the reply indicates to the user of the application what information should be included in the document.

In the context of a request for credit, or for an asset, or for permission, the reply includes natural language subjectively and objectively describing the merits and risks of the request. The reply may also include structured data. The reply, in some embodiments, are referred to as comments for the document.

In some cases, including two distinct LLMs (e.g., a generic LLM 160 and a secondary LLM 170) is important to provide data security and to provide contextually relevant results. Unstructured data (e.g., prompts) sent to the generic LLM are intended to provide unstructured data results. In some cases, the unstructured data sent to the generic LLM has less privacy sensitivity compared to the structured data sent to the secondary LLM. In some other cases, structured data (e.g., additional prompts) sent to the secondary LLM is considered private. The secondary LLM is optimized for analyzing structured data and is configured to return structured data results or unstructured data results, or both.

In the context of a request for credit, or for an asset, or for permission, the input data 138 includes unstructured natural language data and structured data associated with the request document.

In some cases, the input data provided by the user (via the UI 136) includes only natural language, and the UI 136 or the semantic kernel 142 automatically processes the natural language to obtain related structured data. The UI 136 or the semantic kernel adds the structured data to the natural language input. In other words, an input is augmented to include both natural language unstructured data and structured data, whereby, in some cases, the structured data is private to the organization.

In some other cases, the input data 138 from the UI 136 includes both unstructured natural language data and structured data, whereby, in some cases, the structured data is private to the organization. In some cases, the structured data can be positioned amongst the natural language unstructured data, and the semantic kernel 142 identifies and separates the structured data from the input data 138, and identifies and separates the natural language unstructured data from the input data 138.

The semantic kernel 142 is in data communication with the manager module 144, and the manager module 144 is in data communication with the one or more workers 146. The manager module 144 invokes the one or more workers 146. The one or more workers 146 are also called artificial intelligence (AI) plugins. Each worker 146 has stored therein a plurality of prompts. In some cases, the one or more workers 146 are preloaded into the semantic kernel 142. In other words, in some cases, the one or more workers 146 are part of the semantic kernel 142.

In some cases, the manager module 144 generates a stepwise process that includes a sequence of actions 148a, 148b, 148c with each action invoking one or more workers 146.

The application 140 also includes connectors 150. For example, a first connector C1 interfaces between the semantic kernel 142 and the generic LLM 160, and a second connector C2 interfaces between the semantic kernel 142 and the secondary LLM 170.

In some cases, where there are multiple secondary LLMs, there is a separate connector assigned to communicate with each instance of the secondary LLMs.

In operation, the application 140 receives an input from a client device 190. The input is processed by the semantic kernel 142.

The semantic kernel 142 sends the input to the manager module 144, which then invokes the workers 146. In some cases, the workers 146 are invoked in a stepwise sequence. A first worker 146a is invoked to get a first intermediate result, then a second worker 146b is invoked to get a second intermediate result, and so forth.

For a given worker 146 to obtain an intermediate result, the given worker processes the input, or an intermediate result derived from the input, or both, to generate one or more prompts addressed to generic LLM 160 or the secondary LLM 170. The one or more prompts are sent via the manager module 144, the semantic kernel 142, and the connector C1 or C2 corresponding to the generic LLM or the secondary LLM. A reply from the generic LLM 160 or the secondary LLM 170 is returned back to the semantic kernel 142, via the corresponding connector. This semantic kernel 142, in some cases, sends the reply from the generic LLM or the secondary LLM back to the manager module 144, and the manager module may use the reply as an intermediary input to another worker 146.

In some cases, the semantic kernel 142 merges the intermediate replies (or intermediate outputs) from the workers 146 to generate a reply 139. The reply 139 is outputted to the client device 190.

In some cases, the reply 139 includes one or more questions identified by a worker 146. The one or more questions relates to missing information identified by a worker 146, and the worker requests the missing information in the form of questions in the reply.

In some cases, one of the workers 146 is wholly focused on engaging with the generic LLM 160, and another one of the workers 146 is wholly focused on engaging with the secondary LLM 170. In some cases, one of the workers 146 is majorly focused on engaging with the generic LLM 160 (i.e., majority of prompts by the worker are formed and sent to the generic LLM) and minorly focused on engaging with the secondary LLM 170 (i.e., a minority of the prompts by the worker are formed and sent to the secondary LLM). In another case, the reverse occurs.

It will be appreciated that, while the components shown in FIG. 1B for the cloud-based computing cluster 130 can be implemented with the system 100 in FIG. 1A, in some other cases, the components shown in FIG. 1B are instead implemented in an isolated computing server system. In other words, the components shown in FIG. 1B can be implemented as a processing node 180 without the EDPP 120 and the source database system 110.

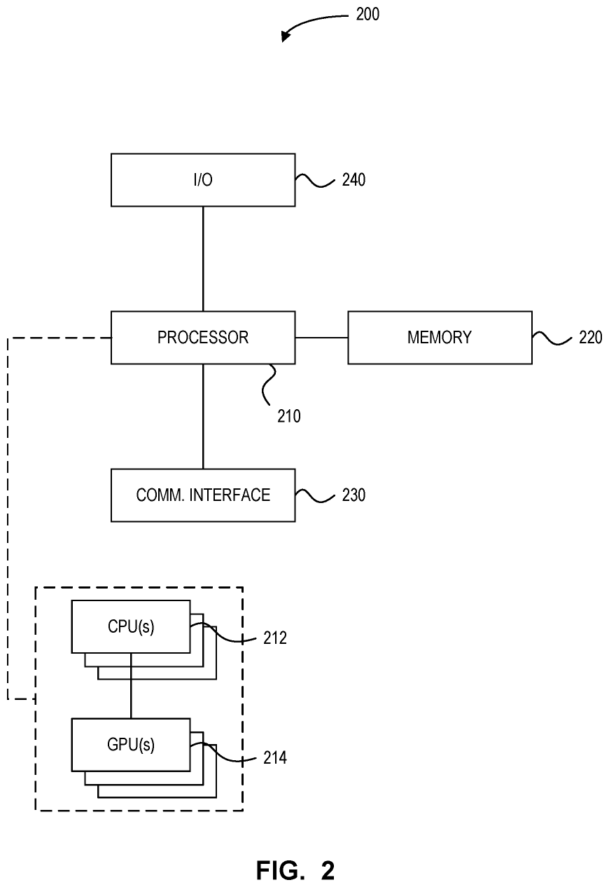

Referring now to FIG. 2, there is illustrated a simplified block diagram of a computer in accordance with at least some embodiments. Computer 200 is an example implementation of a computer such as source database system 110, EDPP 120, processing node 180 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the secondary LLM 170 executes neural network computations on CPU and GPU hardware, such as the system of CPUs 212 and GPUs 214.

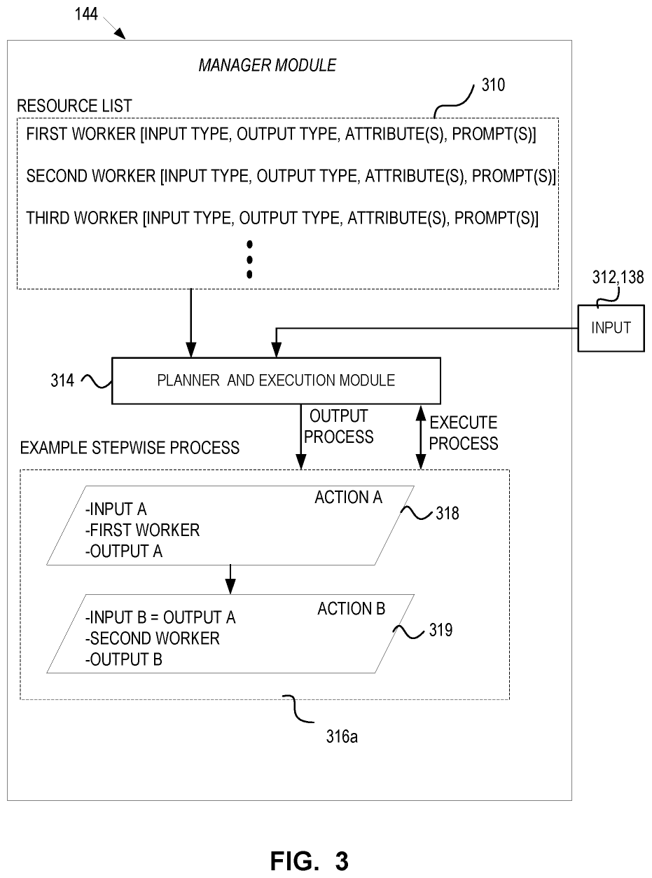

Referring now to FIG. 3, an example embodiment of a manager module 144 is provided. In some cases, the manager module 144 includes a resource list 310. The resource list 310 includes a list of the workers 146 and related information about each worker. For example, the resource list 310 includes the name of the first worker and the related information about the first worker. The related information about the first worker includes, in some cases, the data input type, the data output type, one or more attributes of the first worker, and one or more prompts associated with the first worker. In some cases, the one or more attributes specifies the LLM for which it interacts with. In some cases, the first worker is configured to process unstructured natural language data as specified by its data input type, and is configured to generate prompts to be sent to the generic LLM 160 as specified by its one or more attributes.

Similarly, the list entry of the second worker specifies the second worker name, the data input type, the data output type, one or more attributes of the second worker, and one or more prompts associated with the second worker. In some cases, the one or more attributes specifies the LLM for which it interacts with. In some cases, the second worker is configured to process structured data as specified by its data input type, and is configured to generate prompts to be sent to the secondary LLM 170 as specified by its one or more attributes.

In some cases, the workers can be modified over time and the resource list 310 is updated to reflect the current workers that are preloaded into the semantic kernel 142.

The manager module 144, in some cases, also includes a planner and execution module 314, which processes an input 312 using the resource list 310. In some cases, the input 312 is derived by the semantic kernel using the input 138 from the UI 136. In some other cases, the input 312 is generated by the semantic kernel and includes the input 138 from the UI 136. In some other cases, the input 312 is the input 138 without modification.

In some cases, the planner and execution module 314 determines which workers are available and appropriate to process the input 312 in order to achieve a goal for evaluating and improving the input 312 (or input 138). The planner and execution module 314 may mix and match the workers 146 to generate a stepwise process 316a. The planner and execution module 314 outputs the stepwise process 316a and then executes the stepwise process 316a.

In other words, the manager module 144 is configured to determine a goal derived from the input 312. The manger module 144 is configured to determine that a plurality of workers is associated with the goal. The manager module 144 is configured to then determine, using the plurality of workers, a plurality of prompts organized in a hierarchy to send to generic LLM and to the secondary LLM.

In the example from FIG. 3, the stepwise process 316a includes Action A 318 followed by Action B 319. Action A 318 and Action B 319 are also herein referred to as a first process and a second process. Action A 318 includes processing an input A (e.g., which is from the input 312) using a first worker 146a and obtaining an output A. Action B 319 includes using the output A as an input B for the second worker 146b, to obtain an output B. In some cases, the reply 139 that is returned to the client device 190 includes the output B.

In other words, the manager module 144 invokes the plurality of workers in a stepwise sequence, including invoking the first worker 146a first, and after determining the first worker has completed a first process, the manager module 144 invokes the second worker 146b to execute a second process. In some cases, the input comprises unstructured input data and structured input data, and the first worker 146a invokes the generic LLM 160 by at least generating a first prompt based on the unstructured data input and sending the first prompt to the generic LLM 160. The second worker 146b invokes the secondary LLM 170 by at least generating a second prompt based on the structured input data and sending the second prompt to the secondary LLM 170.

In some cases, the first worker 146a generates a first prompt that is transmitted via the semantic kernel 142 and the first connector C1 to the generic LLM 160. In some cases, the second worker 146b generates a second prompt that is transmitted via the semantic kernel 142 and the second connector C2 to the secondary LLM 170.

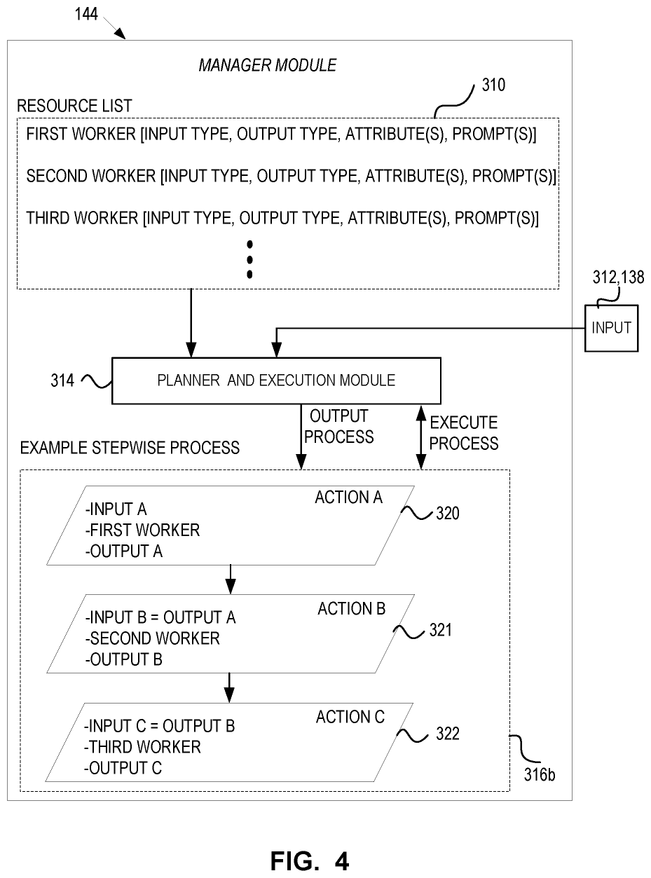

Referring now to FIG. 4, another example embodiment of a stepwise process 316b is provided. The stepwise process 316b includes Action A 320, followed by Action B 321, followed by Action C 322. Action A 320 includes processing an input A (e.g., which is from the input 312) using a first worker 146a and obtaining an output A. Action B 321 includes using the output A as an input B for the second worker 146b, to obtain an output B. Action C 322 includes using the output B as an input C for the third worker 146c, to obtain an output C. In some cases, the reply 139 that is returned to the client device 190 includes the output C.

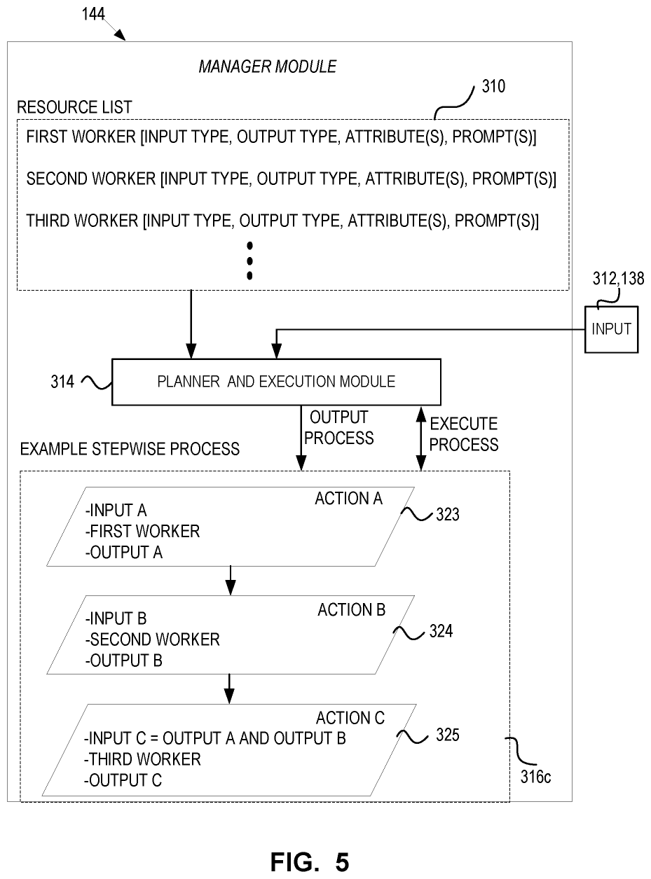

Referring now to FIG. 5, another example embodiment of a stepwise process 316c is provided. The stepwise process 316c includes Action A 323, followed by Action B 324, followed by Action C 325. Action A 323 includes processing an input A, which is from the input 312, using a first worker 146a and obtaining an output A. Action B 324 includes using an input B, which is from the input 312, for the second worker 146b, to obtain an output B. Action C 325 includes using the output A and the output B as an input C for the third worker 146c, to obtain an output C. In some cases, the reply 139 that is returned to the client device 190 includes the output C.

In some cases, other different sequences and combinations of the workers 146 (not shown) are used to generate a stepwise process.

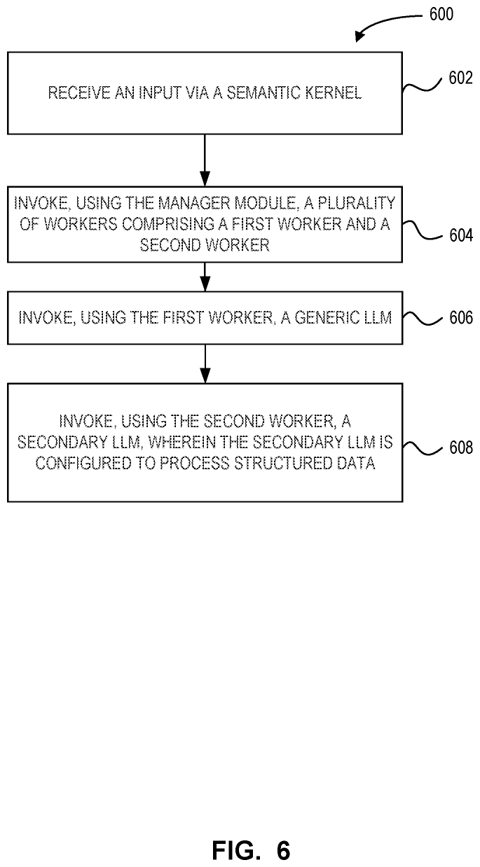

Referring now to FIG. 6, an example process 600 is provided which is executable by a processor.

Block 602: The processor receives an input via a semantic kernel.

Block 604: The processor invokes, using the manager module, the plurality of workers comprising a first worker and a second worker.

Block 606: The processor invokes, using the first worker, a generic LLM.

Block 608: The processor invokes, using the second worker, a secondary LLM, wherein the secondary large language model is configured to process structured data.

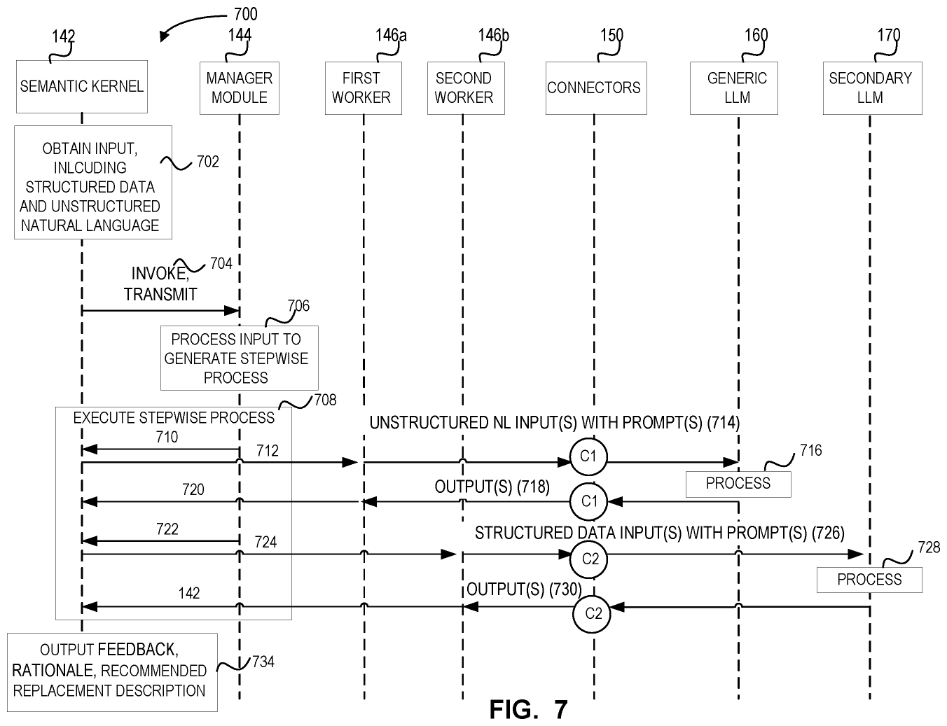

Referring to FIG. 7, another example process 700 is provided using the system shown in FIG. 1B.

Block 702: The semantic kernel 142 obtains input including structured data and unstructured natural language.

Block 704: The semantic kernel 142 invokes the manager module 144 and transmits the input.

Block 706: The manager module 144 processes the input to generate a stepwise process. For example, the stepwise process includes a sequence of actions and each action invokes at least one of the workers 146. Each worker invokes the generic LM160 or a secondary LLM 170 with one or more prompts. In some cases, a given worker 146 will generate a chain of prompts (e.g., a sequence of prompts) to be sent one at a time to a generic LLM160, or to a secondary LLM 170.

Block 708: The manager module 144 executes the stepwise process. An example embodiment of a stepwise process is shown in FIG. 7, but it will be appreciated that other example embodiments of different stepwise processes can be generated by the manager module 144 and executed by the manager module 144.

In the example shown in FIG. 7, the stepwise process includes first using a first worker 146a to invoke a generic LLM 160 and then using a second worker 146b to invoke a secondary LLM 170. Example operations from blocks 710 to 732 are part of the stepwise process.

Block 710: The manager module 144 communicates with the semantic kernel 142 to invoke the first worker 146a.

Block 712: The semantic kernel 142 invokes the first worker 146a.

Block 714: Responsive to the invocation, the first worker 146a uses unstructured natural language input to generate one or more prompts that are sent to the generic LLM 160. In some cases, a sequence of prompts is generated. For example, the sequence of prompts includes a first prompt and a second prompt. The first prompt generates a first intermediate output, and the first intermediate output forms part of the second prompt. The one or more prompts are sent via a first connector C1, which connects to the generic LLM 160.

Block 716: The generic LLM 160 processes the one or more prompts.

Block 718: The one or more outputs from the process (at block 716) are returned to the first worker 146a, via the first connector C1.

Block 720: The semantic kernel 142 receives and processes the one or more outputs from the first worker 146a.

Block 722: The manager module 144 then communicates with the semantic kernel 142 to invoke the second worker 146b.

Block 724: The semantic kernel 142 invokes the second worker 146b.

Block 726: Responsive to the invocation, the second worker 146b uses unstructured natural language input to generate one or more prompts that are sent to the secondary LLM 170. In some cases, a sequence of prompts is generated. The one or more prompts are sent via a second connector C2, which connects to the secondary LLM 170.

Block 728: The secondary LLM 170 processes the one or more prompts.

Block 730: The one or more outputs from the process (at block 728) are returned to the second worker 146b, via the second connector C2.

Block 732: The semantic kernel 142 receives and processes the one or more outputs from the second worker 146b.

Block 734: The semantic kernel 142 uses the output(s) from the first worker 146a and the second worker 146b to compile and output feedback regarding the input provided by the client device 190. In some cases, the feedback is an evaluation regarding whether the input is very good (e.g., meets best practices), satisfactory, or needs improvement. In some cases, the feedback includes one or more questions to the user, so that the user can consider other factors for preparing a document. In some cases, the output also includes rationale or reasoning for the feedback. In some cases, the output includes recommended replacement description to replace the input provided by the client device 190.

In some cases, the process includes receiving, via the manager module, a first intermediate result from the first worker and a second intermediate result from the second worker. The process also includes transmitting the first intermediate result and the second intermediate result from the manager module to the semantic kernel. The process further includes then merging, using the semantic kernel, the first intermediate result and the second intermediate result to generate a reply, wherein the reply comprises unstructured output data. The reply is then outputted using the semantic kernel.

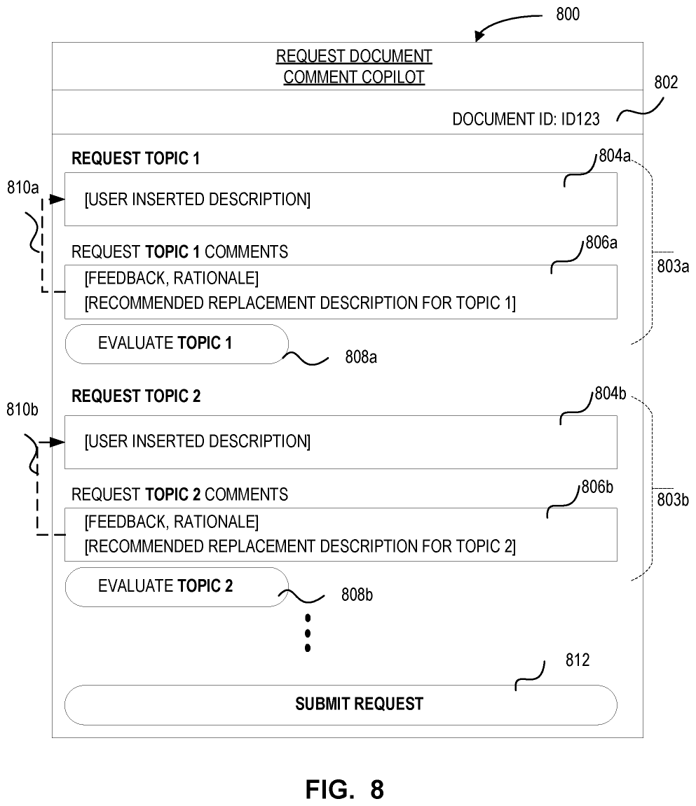

Referring now to FIG. 8, an example embodiment of a screenshot displaying a UI 800, which is viewable using a web browser 192 (or a dedicated application) on the client device 190, is provided. The UI 800 includes a document ID 802. The UI also includes a first topic section 803a and a second topic section 803b.

The first topic section 803a relates to a first topic of a request for a permission, a request to obtain an asset, a request to obtain credit, etc. The second topic section 803b relates to a second topic for the request document. The number of topics and the type of topics for the document could vary depending on the type of request, and the organization that reviews the request document.

In the first topic section 803a, there is a first input field 804a configured to receive user inserted description (e.g., user provided input). There is also a GUI control 808a that, upon being selected or “clicked on”, will cause the user inserted description from the input field 804a to be processed by the semantic kernel 142 and the manager module 144 (amongst other components). In effect, this causes the user inserted description in the first input field 804a to be evaluated. As noted above, the user inserted description in some cases includes a combination of unstructured natural language and structured data, whereby the structured data is considered private to the organization. In some other cases, the user inserted description includes only unstructured natural language, and the semantic kernel or the UI uses the unstructured natural language to obtain related structural data, which forms part of the input to the manager module 144 or semantic kernel 142, or both.

After the input data is processed, according the processes and systems described herein, the output (also called a reply) is provided back to the UI 800 and displayed in the first output field 806a. The output includes, for example, feedback and rationale (e.g., reasons for the feedback). In some cases, the output includes recommended replacement description text and data for topic 1, that could be copied and pasted into the first input field 804a (e.g., via copying and pasting actions by the user or by a copy-and-paste function invoked by the user). The transferring action 810a of the recommended replacement description improves the user inserted description in the first input field 804a.

In some cases, after the recommended replacement description has been inserted into the first input field 804a, the user selects the GUI control 808a again to re-evaluate the updated input in the first input field 804a. This returns updated output that includes updated feedback or comments in the first output field 806a, which, in some cases, are positive and confirm that the recommended replacement description meets the request document criteria and recommended practices.

It will be appreciated that the updating process, including the transferring action 810a, can be repeated or iterated two or more times to improve the quality of the input into the first input field 804a.

Similarly, the second topic section 803b includes a second input field 804b, a second output field 806b, and a second GUI control 808b. These elements operate in a similar way to the elements in the first topic section 803a. Similarly, the recommended replacement description for topic 2 could be transferred to the second input field 804b using a transferring action 810b. In some cases, the evaluation of the input in the second input field 804b and updating the input (e.g., using a transferring action 810b) could be repeated more than one time.

A submit GUI control 812 is also provided. After detecting a user selecting the submit GUI control 812, the inputs in the first input field 804a and the second input field 804b, and any other input fields for different topics, are submitted as part of a request for permission, or to obtain an asset, or to obtain credit, or some other type of request document.

In some cases, a first stepwise process is generated by the manager module 144 for processing the input related to the first input field 804a for the first topic, and a second stepwise process is generated by the manager module 144 for processing the input related to the second input field 804b for the second topic. In some cases, the first stepwise process is different than the second stepwise process. For example, the order of the workers is different between the first and the second stepwise processes. In another example, the combination of workers that are invoked are different between the first and the second stepwise process.

In some cases, by using the generic LLM and a separate secondary LLM, data security for processing private structured data is improved. In some cases, the different workers (e.g., AI plugins) allow for greater customization and dynamic processing of input data. In some cases, the custom generation of a stepwise process for different actions, which invoke different workers and LLMs, help to segment the processing of data and to reduce data resource requirements for processing pending data.

In some cases, the systems and methods provided herein improve the rate at which a request for permission (or another type of request document) can be completed and submitted to an authority. In some cases, the systems and methods provided herein improve a success rate at which a request for permission (or another type of request document) is approved.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g. 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for processing input data, the system comprising:
a memory, a communication interface, and a processor operatively coupled to the memory and the communication interface;
an application stored in the memory and executable by the processor, and the application comprising a semantic kernel, a manager module, and a plurality of workers;
the processor configured to:
receive an input via the semantic kernel;
invoke, using the manager module, the plurality of workers comprising a first worker and a second worker;
invoke, using the first worker, a generic large language model; and
invoke, using the second worker, a secondary large language model,
wherein the secondary large language model is configured to process structured data.

2. The system of claim 1, wherein the secondary large language model is trained using specific domain knowledge.

3. The system of claim 2, wherein the secondary language model is private to an organization, and the specific domain knowledge comprises training data labeled as private to the organization; wherein the generic language model is public; and wherein the input comprises structured input data labeled as private to the organization and unstructured natural language.

4. The system of claim 1, wherein the manager module invokes the plurality of workers in a stepwise sequence, including invoking the first worker first, and after determining the first worker has completed a first process, the manager module invokes the second worker.

5. The system of claim 1, wherein the input comprises unstructured input data and structured input data, and the first worker invokes the generic large language module by at least generating a first prompt based on the unstructured data input and sending the first prompt to the generic large language model.

6. The system of claim 5, wherein the second worker invokes the secondary large language module by at least generating a second prompt based on the structured input data and sending the second prompt to the secondary large language model.

7. The system of claim 1, wherein the application further comprises a plurality of connectors that are in data communication with the semantic kernel, the plurality of connectors comprising a first connector configured to communicate with the generic large language model and a second connector configured to communicate with the secondary large language model; and
wherein the first worker generates a first prompt that is transmitted via the semantic kernel and the first connector to the generic large language model; and
wherein the second worker generates a second prompt that is transmitted via the semantic kernel and the second connector to the secondary large language model.

8. The system of claim 1, wherein the processor is further configured to:
determine, using the manager module, a goal derived from the input;
determine, using the manager module, that the plurality of workers is associated with the goal; and
determine, using the plurality of workers, a plurality of prompts organized in a hierarchy to send to generic large language model and to the secondary large language model.

9. The system of claim 1, wherein the plurality of workers further comprises a third worker, and the processor is further configured to:
invoke, using the third worker, the generic large language model and the secondary large language model.

10. The system of claim 1, wherein the processor is further configured to:
receive, via the manager module, a first intermediate result from the first worker and a second intermediate result from the second worker;
transmit the first intermediate result and the second intermediate result from the manager module to the semantic kernel;
merge, using the semantic kernel, the first intermediate result and the second intermediate result to generate a reply, wherein the reply comprises unstructured output data; and
output the reply using the semantic kernel.

11. A method for processing input data, the method executed in a computing environment comprising one or more processors and memory, wherein the memory stores at least an application, the application comprising a semantic kernel, a manager module, and a plurality of workers, and the method comprising:
receiving an input via the semantic kernel;
invoking, using the manager module, the plurality of workers comprising a first worker and a second worker;
invoking, using the first worker, a generic large language model; and
invoking, using the second worker, a secondary large language model, wherein the secondary large language model is configured to process structured data.

12. The method of claim 11, wherein the secondary large language model is trained using specific domain knowledge.

13. The method of claim 12, wherein the secondary language model is private to an organization, and the specific domain knowledge comprises training data labeled as private to the organization; wherein the generic language model is public; and wherein the input comprises structured input data labeled as private to the organization and unstructured natural language.

14. The method of claim 11, further comprising: the manager module invoking the plurality of workers in a stepwise sequence, including invoking the first worker first, and after determining the first worker has completed a first process, the manager module invoking the second worker.

15. The method of claim 11, wherein the input comprises unstructured input data and structured input data, and wherein the first worker invokes the generic large language module by at least generating a first prompt based on the unstructured data input and sending the first prompt to the generic large language model.

16. The method of claim 15, wherein the second worker invokes the secondary large language module by at least generating a second prompt based on the structured input data and sending the second prompt to the secondary large language model.

17. The method of claim 11, wherein the application further comprises a plurality of connectors that are in data communication with the semantic kernel, the plurality of connectors comprising a first connector configured to communicate with the generic large language model and a second connector configured to communicate with the secondary large language model; and wherein the method further comprising:
the first worker generating a first prompt that is transmitted via the semantic kernel and the first connector to the generic large language model; and
the second worker generates a second prompt that is transmitted via the semantic kernel and the second connector to the secondary large language model.

18. The method of claim 11, further comprising:
determining, using the manager module, a goal derived from the input;
determining, using the manager module, that plurality of workers are associated with the goal; and
determining, using the plurality of workers, a plurality of prompts organized in a hierarchy to send to generic large language model and to the secondary large language model.

19. The method of claim 11, further comprising:
receiving, via the manager module, a first intermediate result from the first worker and a second intermediate result from the second worker;
transmitting the first intermediate result and the second intermediate result from the manager module to the semantic kernel;
merging, using the semantic kernel, the first intermediate result and the second intermediate result to generate a reply, wherein the reply comprises unstructured output data; and
outputting the reply using the semantic kernel.

20. A non-transitory computer readable medium storing computer executable instructions which, when executed by at least one computer processor, cause the at least one computer processor to carry out a method for processing input data, the non-transitory computer readable medium further comprising an application, wherein the application comprising a semantic kernel, a manager module, and a plurality of workers, and the method comprising:
receiving an input via the semantic kernel;
invoking, using the manager module, the plurality of workers comprising a first worker and a second worker;
invoking, using the first worker, a generic large language model; and
invoking, using the second worker, a secondary large language model, wherein the secondary large language model is configured to process structured data.
